(19) United States
(12) Patent Application Publication
(10) Pub. No.: US 2010/0150008 A1
(43) Pub. Date: Jun. 17, 2010

(54) APPARATUS AND METHOD FOR DISPLAYING STATE OF NETWORK

(76) Inventors: Seon Gyoung Sohn, Daejeon (KR); Chi Yoon Jeong, Daejeon (KR); Beom Hwan Chang, Daejeon (KR); Soo Hyung Lee, Daejeon (KR); Hyo Chan Bang, Daejeon (KR); Geon Lyang Kim, Daejeon (KR); Hyun Joo Kim, Daejeon (KR); Won Joo Park, Daejeon (KR); Jong Ho Ryu, Choongcheongnam-do (KR); Jong Hyun Kim, Daejeon (KR); Jung Chan Na, Daejeon (KR); Jong Soo Jang, Daejeon (KR); Sung Won Sohn, Daejeon (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/530,193

(22) PCT Filed: Mar. 7, 2008
(86) PCT No.: PCT/KR2008/001298

§ 371 Date: Feb. 19, 2010

(30) Foreign Application Priority Data
Mar. 8, 2007 (KR) 10-2007-0022971

(51) Int. Cl. H04L 12/26

(52) U.S. Cl. 370/252

(57) ABSTRACT

There are provided a network state display apparatus and method capable of easily determining a present network security state in real time by analyzing an abnormality and harmful traffic deteriorating performance of a network in software by using a result of combining essential characteristics of traffic, a distinct dispersion, and an entropy and displaying the network state to be intuitionally recognized, the method including selecting and combining three of a source address, a source port, a destination address, and a destination port of collected traffic and calculating a distinct dispersion and an entropy of a residual one therefrom; displaying the calculated distinct dispersion and entropy on a security radar where the distinct dispersion and the entropy are assigned to an angle and a radius; determining whether a network state is abnormal, based on a result displayed on the security radar; and detecting reporting detailed information on abnormal traffic causing the abnormal network state.

### TECHNICAL FIELD

The present invention relates to a network state display apparatus and method capable of easily determining a present network security state in real time by intuitionally displaying an abnormality and harmful traffic deteriorating performance of a network.

The work related to the present invention was partly supported by the IT R&D program of MIC/IITA [2005-S-402-02, Title: The Development of the High Performance Network Security].

### BACKGROUND ART

Recently, as networks are generally used, illegal accesses via a network are also increased. Accordingly, importance of network security technology to detect and prevent an abnormal phenomenon of the network, particularly, an illegal access, increases.

In general, to detect an abnormal state of a network, that is, an abnormal state due to an attack, the development of an item is analyzed by using a rate of one of traffic information of the network, such as a network address, a protocol, a port number, and a number of packets or an abnormal state is displayed by expressing data transmitted via the network as a coordinate plane or a geometrical figure according to certain regulations, as an entire network.

Accordingly, according to conventional methods, it is difficult to accurately distinguish and express a certain abnormal state or a network phenomenon according to a certain attack and it is very hard to detect an abnormal form according to a new attack. In addition, when there are present a plurality of attacks, a small number of attacks are generally covered up.

Also, a network state image or graph expressed according to conventional methods show only whether traffic is normal and does not accurately display a form of an attack. Accordingly, it is impossible to provide a method corresponding to an abnormal state and there is required a lot of time to detect harmful traffic causing an abnormal phenomenon and coping with the harmful traffic, thereby increasing damages thereof.

Korean Patent Publication No. 2004-0072365 (published on Aug. 18, 2004) discloses “Apparatus and Method for Displaying States of Network” in which connection information is extracted by analyzing a network initial connection request packet via an external communication network, displaying a present network state in the form of coordinate point data by analyzing the connection information, and attack characteristics of an abnormal network state is determined by using the displayed coordinate point data.

However, since point data for each connection on a network is used and a large number of points is displayed on a coordinate system as described above, it is difficult to accurately distinguish and express a certain abnormal phenomenon or a network state according to a certain attack, it is very hard to detect an abnormal form according to a new attack. In addition, when there are present a plurality of attacks, a small number of attacks are covered up, which make detection difficult.

### DISCLOSURE OF INVENTION

### Technical Problem

An aspect of the present invention provides a network state display apparatus and method capable of easily determining a present network security state in real time by analyzing an abnormality and harmful traffic deteriorating performance of a network in software by using a result of combining essential characteristics of traffic, a distinct dispersion, and an entropy and displaying the network state to be intuitionally recognized.

### Technical Solution

According to an aspect of the present invention, there is provided a network state display apparatus including: a traffic characteristics extraction unit selecting and combining three of a source address, a source port, a destination address, and a destination port of collected traffic and calculating a distinct dispersion and an entropy of a residual one therefrom; a network state display unit displaying a distinct dispersion and an entropy extracted from the traffic characteristics extraction unit, on a security radar having an angle axis and a radius axis; and a traffic abnormality determination unit determining whether a network state is abnormal, based on a result of the display on the security radar by the network state display unit and detecting and reporting harmful traffic or abnormal traffic causing the abnormal network state.

According to another aspect of the present invention, there is provided a network state display method including: selecting and combining three of a source address, a source port, a destination address, and a destination port of collected traffic and calculating a distinct dispersion and an entropy of a residual one therefrom; displaying the calculated distinct dispersion and entropy on a security radar where the distinct dispersion and the entropy are assigned to an angle and a radius; determining whether a network state is abnormal, based on a result displayed on the security radar; and detecting and reporting detailed information on abnormal traffic causing the abnormal network state.

### BRIEF DESCRIPTION OF THE DRAWINGS

FIG. 1 is a block diagram illustrating a network state display apparatus according to an exemplary embodiment of the present invention;

FIG. 2 is a flowchart illustrating a network state display method according to an exemplary embodiment of the present invention;

FIG. 3 is a diagram illustrating an example of a security radar embodied by the present invention; and

FIG. 4 illustrates a process of clustering a display result of the security radar.

### BEST MODE FOR CARRYING OUT THE INVENTION

Hereinafter, exemplary embodiments of the present invention will now be described in detail with reference to the accompanying drawings. Only, in describing operations of the exemplary embodiments in detail, when it is considered that a detailed description on related well-known functions or constitutions unnecessarily may make essential points of the present invention be unclear, the detailed description will be omitted.

Also, in the drawings, the same reference numerals are used throughout to designate the same or similar components.

In addition, throughout the specification, when it is describe that a part is “connected to” another part, this includes not only a case of “being directly connected to” but also a case of “being electrically connected to” interposing another device therebetween. Also, when it is described that an apparatus “includes” an element and there is no opposite description thereof, this is not designate that the apparatus excludes other elements but designates that the apparatus may further include other elements.

Also the term of module indicates a unit for processing a certain function or operation, which can be embodied by software, hardware, or a combination of software and hardware.

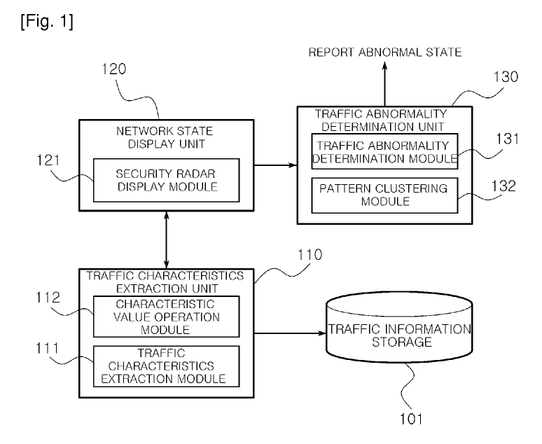

FIG. 1 is a block diagram illustrating a network state display apparatus according to an exemplary embodiment of the present invention.

Referring to FIG. 1, the network state display apparatus includes a traffic characteristics extraction unit 110 clustering the collected traffic for each protocol by referring to information on the collected traffic and selecting and combining three of a source address, a source port, a destination address, and a destination port of collected traffic and calculating a distinct dispersion and an entropy of a residual one therefrom, a network state display unit 120 displaying a distinct dispersion extracted from the traffic characteristics extraction unit 110 to correspond to an angle of a circle and an entropy extracted from the traffic characteristics extraction unit 110 to correspond to a radius of the circle, as symbols identifying a protocol and a port, and a traffic abnormality determination unit 130 determining whether a network state is abnormal, based on a result of the display on a security radar by the network state display unit 120 and detecting and reporting harmful traffic or abnormal traffic causing the abnormal network state.

The traffic characteristics extraction unit 110 includes a traffic characteristics extraction module 111 extracting a protocol, the source address, the source port, the destination address, and the destination port of the collected traffic, and clustering the collected traffic for each protocol; and a characteristic value operation module 112 calculating a distinct dispersion and an entropy of a residual one by combining three of the source address, the source port, the destination address, and the destination port for each cluster, based on the extracted characteristics. The traffic characteristics extraction unit 110 may cluster the collected traffic or calculate the distinct dispersion and entropy when a number of traffic connecting a source to a destination is greater than a predetermined threshold, thereby increasing operation efficiency by reducing unnecessary operation and processing.

The network state display unit 120 includes a security radar display module 121 displaying the calculated distinct dispersion and entropy on the security radar expressed as a circle where an angle is equally divided by N and a radius is equally divided by M.

The traffic abnormality determination unit 130 includes a traffic abnormality determination module 131 determining whether the network state is abnormal, from the displayed security radar; and a pattern clustering module 132 clustering the harmful traffic or abnormal traffic causing the abnormality based on the determination and detecting and reporting detailed information.

The traffic abnormality determination unit 130 clusters the same characteristics on the security radar where the calculated distinct dispersion and entropy are displayed, determines whether there is an abnormality by detecting detailed characteristics for each cluster, and reports information on harmful traffic, which will be described later in detail.

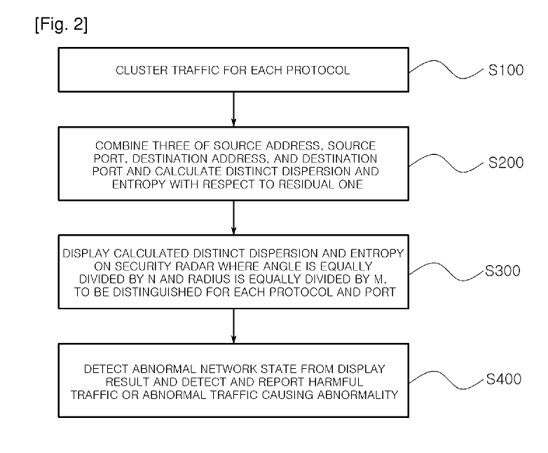

FIG. 2 is a flowchart illustrating a network state display method performed by the network state display apparatus, according to an exemplary embodiment of the present invention.

In the network state display apparatus according to an exemplary embodiment of the present invention, the traffic characteristics extraction unit 110 analyzes network traffic information collected by an external traffic information collector (not shown) and clusters traffic for each protocol (S100). With respect to the clustered traffic, three of a source address, a source port, a destination address, and a destination port are selected and combined, and a distinct dispersion and an entropy with respect to a residual one are calculated (S200). A result of analyzing the calculated traffic characteristics, that is, the distinct dispersion and entropy are stored in a traffic information storage 101.

The network state display unit 120 displays the distinct dispersion and entropy calculated by the traffic characteristics extraction unit 110 on a security radar shown as a circle where an angle is equally divided by N and a radius is equally divided by M and the angle and the radius indicate a distinct dispersion and an entropy, respectively, by using the security radar display module 121 (S300). In this case, different color and/or symbols are used to display to be distinguished for each protocol and port.

The traffic abnormality determination unit 130 detects whether a network state is abnormal by referring to the security radar displayed by the network state display unit 120 and a state displayed thereon and detects and reports harmful traffic or abnormal traffic causing an abnormal state (S400).

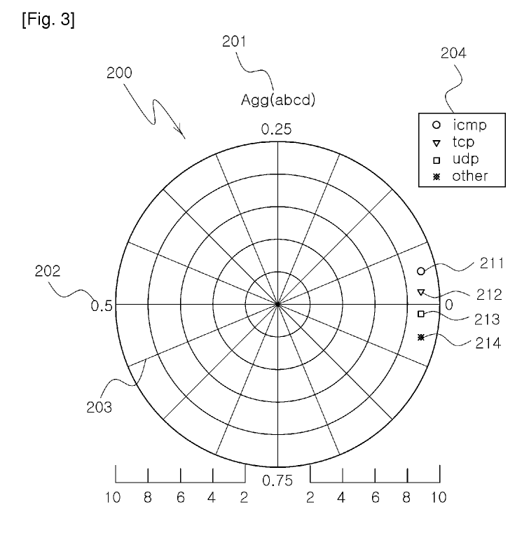

FIG. 3 is a diagram illustrating an example of a security radar 200 displaying a network state, according to an exemplary embodiment of the present invention.

Referring to FIG. 3, the security radar 200 includes a header 201 indicating elements of characteristics included in a cluster, such as a source address, a source port, a destination port, and a destination address. For example, the header 201 may be shown as Agg 1110, which indicates a security radar clustering the collected traffic by using the source address, the source port, and the destination port and extracting and calculating a distinct dispersion 202 and an entropy 203 of the destination address.

In the security radar 200, an angle indicates the distinct dispersion 202 and a radius indicates the entropy 203. In this case, the distinct dispersion and the entropy are shown as different symbols for each protocol, thereby distinguishing a distinct dispersion and entropy for each protocol.

Hereinafter, a method of obtaining a distinct dispersion Dx and entropy H, according to an exemplary embodiment of the present invention, will be described in detail.

The distinct dispersion Dx is one of {a, b, c, d}, which are 0, and is calculated by Equation 1,

$$Dx = \frac{Distinct ( x )}{n ( event )} \qquad Equation ( 1 )$$

wherein n(event) indicates a number of the entire collected traffic, and Distinct(x) indicates a number of independent items when x is extracted from the entire traffic and arranged. In addition, x indicates items such as the source address, the source port, the destination address, and the destination port. For example, when x={21, 23, 53, 53, 80, 80}, Distinct(x)=4. For example, in the case of Agg 1110 in the security radar, a distinct dispersion Dx of a destination address becomes

$$\frac{numberofindependentdestinationaddress}{numberofentireevent}$$

The entropy H is obtained by following Equation 2, and a modified entropy E is obtained by following Equation 3 referring to Equation 2. In Equation 2, n indicates a number of independent items Distinct(x), and P indicates a rate of showing each of the independent items. In Equation 3, n indicates a number of entire collected traffic and do indicates a number of different items (distinct flow_count).

$$\begin{matrix}H = - {\sum }_{i = 1}^{n} {p}_{i} {log}_{2} {p}_{i} & Equation ( 2 ) \\ E = H \times \sqrt{\frac{dn}{n}} & Equation ( 3 )\end{matrix}$$

The distinct dispersion Dx and the modified entropy E correspond to an angle and radius of a circle respectively, and are shown as one point on the security radar 200. The point may be shown as a different symbol according to a protocol.

As described above, when a network state is displayed on the security radar 200, the traffic abnormality determination unit 130 determines whether there is an abnormality by using the security radar 200 and analyzes and reports traffic causing the abnormality.

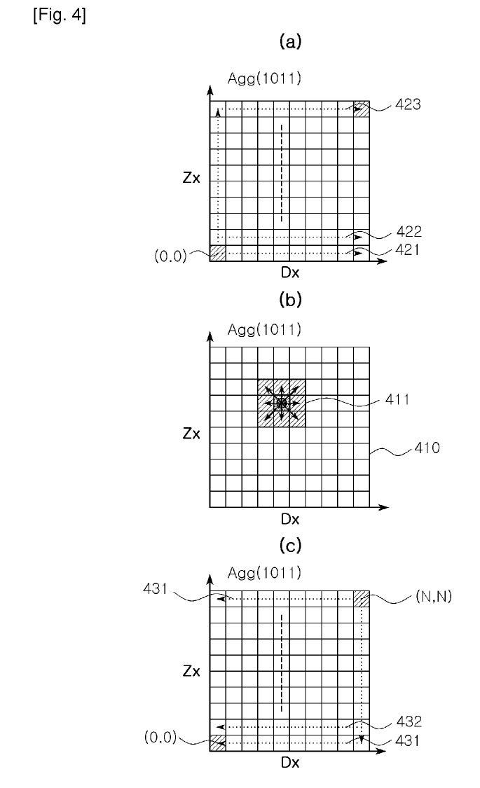

FIG. 4 illustrates a process of determining whether there is an abnormality, which is performed by the traffic abnormality determination unit 130 in S400.

In the process, distinct dispersion values and entropy values displayed on the security radar 200 are clustered according to similarity, information such as a port list for each protocol, a frequency for each port, a rate of each port to entire data, and a location and area present in the security radar is extracted from each cluster, it is determined whether there is an abnormality, and abnormal or harmful traffic causing the abnormality is clustered.

To cluster a result displayed on the security radar 200, the distinct dispersion value Dx and an entropy value Ex of the security radar 200 should be converted into a two-dimensional plane. In this case, since the distinct dispersion value Dx is present within a range between 0 and 1 and a range of the entropy value Ex is uncertain, there is used a value Zx obtained by mapping as a value within a range between 0 and 1 by using an arbitrary maximum value determined by a user.

In the present invention, to cluster, as shown in (a) of FIG. 4, the security radar 200 are converted into a two-dimensional plane formed of a distinct dispersion Dx and an entropy mapping value Zx and the two-dimensional plane is divided into N×N number of lattices.

As shown in (b) of FIG. 4, each lattice on the two-dimensional plane is compared with eight lattices adjacent thereto to calculate similarity. In this case, to calculate the similarity between the lattices, following Equation 4 is used.

$$s ( x , y ) = {\sum }_{i = 1}^{k} {\sum }_{j = 1}^{l} {w}_{ixy} f ( {c}_{ijx} , {v}_{ijx} , {c}_{ijy} , {v}_{ijy} ) \qquad Equation ( 4 )$$

wherein s(x, y) that is a similarity between a lattice x and an another adjacent lattice y is determined by the sum of a weight w_{ixy} with respect to k number of protocols, (cᵢⱼₓ, c_{ijy}) that is a frequency of a jth port of the ith protocol present in the lattice, and (vᵢₕₓ, v_{ijy}) that is rate of an entire frequency.

As a result of the comparison, when the similarity between the lattices is greater than a certain threshold, the lattices are determined as the same cluster. When the similarity is smaller than the threshold, the lattices are determined as different clusters, respectively.

The similarity comparison between the lattice x and the adjacent lattices may be performed in an order of 421, 422, and 423, which moves from (0, 0) to (N, N) of the two-dimensional plane as shown in (a) of FIG. 4, or as shown in (b) of FIG. 4, in an order of 331, 332, and 333, which moves from (N, N) to (0, 0), thereby clustering the lattices on the two-dimensional.

Data determined as the same cluster by the clustering may have the same distinct number and the distinct number is used in the security radar to indicate that the data is included in the same cluster.

With respect to the same cluster, information such as a port list for each protocol, a frequency for each port, a rate of each port to entire data, and a location or area present in the security radar is extracted from each cluster. It is determined by using the information whether there is an abnormal traffic.

The present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

As described above, the network state display apparatus and method may determine an abnormal state deteriorating performance of a network by using a result of combination of essential characteristics of a traffic event, a distinct dispersion, an entropy, and clustering information and may detect a harmful traffic or abnormal traffic causing the abnormal state.

Also, the operation process of the network state display apparatus is automated by a program, thereby enabling a quick countermeasure against the abnormal state without an administrator. Also, since it may be recognized at a glance that whether an abnormal state occurs and information on the harmful traffic or abnormal traffic causing the abnormal state via a security radar, the administrator may quickly recognize and cope with the abnormal state.

While the present invention has been shown and described in connection with the exemplary embodiments, it will be apparent to those skilled in the art that modifications and variations can be made without departing from the spirit and scope of the invention as defined by the appended claims.

1. A network state display apparatus comprising:
a traffic characteristics extraction unit selecting and combining three of a source address, a source port, a destination address, and a destination port of collected traffic and calculating a distinct dispersion and an entropy of a residual one therefrom;
a network state display unit displaying a distinct dispersion and an entropy extracted from the traffic characteristics extraction unit, on a security radar having an angle axis and a radius axis; and
a traffic abnormality determination unit determining whether a network state is abnormal, based on a result of the display on the security radar by the network state display unit and detecting and reporting harmful traffic or abnormal traffic causing the abnormal network state.

2. The apparatus of claim 1, wherein the traffic characteristics extraction unit clusters the collected traffic for each protocol before the calculating a distinct dispersion and an entropy and calculates a distinct dispersion and an entropy for each protocol.

3. The apparatus of claim 2, wherein the traffic characteristics extraction unit clusters traffic for each protocol when the traffic corresponds to a case where a number of entire traffic of a source-destination connection is greater than a predetermined number.

4. (canceled)

5. The apparatus of claim 2, wherein the traffic characteristics extraction unit calculates the distinct dispersion Dx by using following Equation 1,
$$Dx = \frac{Distinct ( x )}{n ( event )} \qquad Equation ( 1 )$$
wherein x indicates items such as the source address, the source port, the destination address, and the destination port, n(event) indicates a number of the entire collected traffic, and Dx indicates a number of independent items when x is extracted from the entire traffic and arranged.

6. The apparatus of claim 2, wherein the traffic characteristics extraction unit obtains the entropy by using following Equation 2 and calculates a modified entropy E by using following Equation 3,
$$\begin{matrix}H = - {\sum }_{i = 1}^{n} {p}_{i} {log}_{2} {p}_{i} & Equation ( 2 ) \\ E = H \times \sqrt{\frac{dn}{n}} & Equation ( 3 )\end{matrix}$$
wherein in Equation 2, n indicates a number of independent items (Distinct(x)), P indicates a rate of showing each of the independent items, in Equation 3, n indicates a number of entire collected traffic, and do indicates a number of different items (distinct flow_count).

7. The apparatus of claim 3, wherein the traffic characteristics extraction unit comprises:
a traffic characteristics extraction module extracting a protocol, the source address, the source port, the destination address, and the destination port of the collected traffic, and clustering the collected traffic for each protocol; and
a characteristic value operation module calculating a distinct dispersion and an entropy of a residual one by combining three of the source address, the source port, the destination address, and the destination port for each cluster, based on the extracted characteristics.

8. The apparatus of claim 3, wherein the network state display unit displays points corresponding to the calculated distinct dispersion and the entropy on the security radar where an angle is divided by the distinct dispersion and a radius is divided by the entropy.

9. The apparatus of claim 8, wherein the network state display unit displays the distinct dispersion and the entropy to be distinguished for each protocol.

10. The apparatus of claim 9, wherein the traffic abnormality determination unit comprises:
a traffic abnormality determination module determining whether the network state is abnormal, from the displayed security radar; and
a pattern clustering module clustering the harmful traffic or abnormal traffic causing the abnormality based on the determination and detecting and reporting detailed information.

11. The apparatus of claim 10, wherein the traffic abnormality determination module clusters points displayed on the security radar, having the same characteristics, by comparing similarity therebetween, determines whether there is an abnormality by extracting detailed information for each cluster, and reports information on traffic causing the abnormality.

12. The apparatus of claim 11, wherein the extracted detailed information to determine whether there is an abnormality comprises one or more of a port list for each protocol, a frequency for each port, a ratio of a port to entire data, and one of a location and area on the security radar.

13. The apparatus of claim 11, wherein the traffic abnormality determination unit converts the security radar into a two-dimensional plane, divides the two-dimensional plane into a plurality of lattice having lines and rows, calculates similarity between each of the lattices and eight lattices adjacent thereto by following Equation 4, determines that there are the same characteristics when the calculated similarity is greater than a predetermined threshold, and clusters the lattices having the same characteristics,
$$s ( x , y ) = {\sum }_{i = 1}^{k} {\sum }_{j = 1}^{l} {w}_{ixy} f ( {c}_{ijx} , {v}_{ijx} , {c}_{ijy} , {v}_{ijy} ) \qquad Equation ( 4 )$$
wherein s(x, y) indicates a similarity between a lattice x and an another adjacent lattice y, k indicates the number of protocols, w_{ixy}, is a weight for an ith protocol present in the lattice, (cᵢⱼₓ, c_{ijy}) indicates a frequency of a jth port of the ith protocol present in the lattice, and (vᵢⱼₓ, v_{ijy}) indicates an entire frequency.

14. A network state display method comprising:
selecting and combining three of a source address, a source port, a destination address, and a destination port of collected traffic and calculating a distinct dispersion and an entropy of a residual one therefrom;
displaying points corresponding to the calculated distinct dispersion and entropy on a security radar where the distinct dispersion and the entropy are assigned to an angle and a radius;
determining whether a network state is abnormal, based on a result displayed on the security radar; and
detecting and reporting detailed information on abnormal traffic causing the abnormal network state.

15. The method of claim 14, further comprising clustering the collected traffic for each protocol, before the calculating a distinct dispersion and an entropy.

16. The method of claim 15, wherein, in the displaying the calculated distinct dispersion and entropy, the distinct dispersion and the entropy are displayed to be distinguished for each protocol.

17. (canceled)

18. (canceled)

19. The method of claim 14, wherein, in the calculating a distinct dispersion and an entropy of a residual one therefrom, the distinct dispersion Dx is calculated by following Equation 1,
$$Dx = \frac{Distinct ( x )}{n ( event )} \qquad Equation ( 1 )$$
wherein x indicates items such as the source address, the source port, the destination address, and the destination port, n(event) indicates a number of the entire collected traffic, and Distinct(x) indicates a number of independent items when x is extracted from the entire traffic and arranged.

20. The method of claim 14, wherein, in the calculating a distinct dispersion and an entropy of a residual one therefrom, the entropy is obtained by using following Equation 2 and a modified entropy E is calculated by using following Equation 3,
$$\begin{matrix}H = - {\sum }_{i = 1}^{n} {p}_{i} {log}_{2} {p}_{i} & Equation ( 2 ) \\ E = H \times \sqrt{\frac{dn}{n}} & Equation ( 3 )\end{matrix}$$
wherein in Equation 2, n indicates a number of independent items (Distinct(x)), P indicates a rate of showing each of the independent items, in Equation 3, n indicates a number of entire collected traffic, and do indicates a number of different items (distinct flow_count).

21. The method of claim 14, wherein, in the determining whether a network state is abnormal, a similarity between points displayed on the security radar is compared, the points having the same characteristics are clustered, detailed information for each cluster is extracted, and it is determined whether there is an abnormality.

22. The method of claim 21, wherein the detailed information extracted for determining whether there is an abnormality comprises one or more of a port list for each protocol, a frequency for each port, a rate of a port to entire data, and one of a location and area on the security radar.

23. The method of claim 21, wherein the determining whether a network state is abnormal comprises:
converting the security radar into a two-dimensional plane and dividing the two-dimensional plane into a plurality of lattices having lines and rows;
calculating a similarity between each of the lattices and eight lattices adjacent thereto for each lattice by following Equation 4;
determining that the lattices have the same characteristics when the calculated similarity is greater than a predetermined threshold and clustering the lattices,
$$s ( x , y ) = {\sum }_{i = 1}^{k} {\sum }_{j = 1}^{l} {w}_{ixy} f ( {c}_{ijx} , {v}_{ijx} , {c}_{ijy} , {v}_{ijy} ) \qquad Equation ( 4 )$$
wherein s(x, y) indicates a similarity between a lattice x and an another adjacent lattice y, k indicates the number of protocols, w_{ixy} is a weight for an ith protocol present in the lattice, (cᵢⱼₓ, c_{ijy}) indicates a frequency of a jth port of the ith protocol present in the lattice, and (vᵢⱼₓ, v_{ijy}) indicates an entire frequency.
